(19) United States
(12) Patent Application Publication
(10) Pub. No.: US 2010/0294473 A1
(43) Pub. Date: Nov. 25, 2010

(54) Tube for heat exchanger and method for manufacturing the same

(76) Inventors: Hidenobu Kameda, Saitama (JP); Hiroyuki Yoshida, Saitama (JP)

Correspondence Address: WENDEROTH, LIND & PONACK, L.L.P., 1030 15th Street, N.W.,, Suite 400 East, Washington, DC, 20005-1503, US

(21) Appl. No.: 12/311,863

(22) PCT Filed: Oct. 17, 2007
(86) PCT No.: PCT/JP2007/070239

§ 371 Date: Apr. 16, 2009

(30) Foreign Application Priority Data
Oct. 18, 2006 (JP) 2006-283529

(51) Int. Cl. F28F 1/20; B23P 15/26

(52) U.S. Cl. 165/181; 29/890.046

(57) ABSTRACT

A tube for a heat exchanger includes a tube main body (10) with a long plate shape in an extrusion direction and formed with a plurality of fluid paths (1a) through which a fluid for heat exchange flows internally along the extrusion direction, a plurality of concave parts formed with intervals in a pressing direction in which either an upper surface part (1c) of the tube, that is, a surface of one side in a thickness direction of the tube main body (10) or a lower surface part (1d) of the tube, that is, a surface of a reverse direction to the upper surface part (1c) is pressed in the direction, convex parts (1b) projected in a direction that narrows a cross sectional area of the fluid paths (1a) are formed by the pressed concave parts in the fluid path (1a).

### TECHNICAL FIELD

The present invention relates to a tube for a heat exchanger and a manufacturing method thereof used in a heat exchanger for an automobile or an industry machinery, that is, a radiator for cooling an engine, a condenser for an air conditioning device and an evaporator or the like. In particular, the present invention relates to a tube formed by extrusion molding in which a plurality of fluid paths are formed along an extrusion direction through which the fluid for heat exchange flow.

### BACKGROUND ART

Conventionally, a heat exchanger is known in which a plurality of tubes for the heat exchanger and a plurality of fins are layered. Furthermore, for example, JP2000-193387A describes a tube for a heat exchanger in which a plurality of fluid paths through each of which a fluid for the heat exchanger flows are formed in the interior of the tube. A plurality of projections are disposed with intervals in an extrusion direction in each fluid path so that disturbed flow is generated to the fluid flowing through the fluid paths and heat transfer efficiency is improved.

### DISCLOSURE OF THE INVENTION

### Problem to be Solved by the Invention

However, the aforementioned tube for the heat exchanger is formed by joining two plate materials and is more expensive than an extrusion molding product. In addition, if an extrusion tube formed by a cheap extrusion molding is used, the fluid paths are respectively formed to have a constant cross sectional area shape. Therefore, it is difficult to dispose the projections with intervals in an extrusion direction and improve heat transfer efficiency by the projections formed in the fluid paths.

An object of the present invention is to provide a tube for a heat exchanger that can improve heat transfer efficiency of the tube for the heat exchanger formed by extrusion molding.

### Means for Solving the Problem

To accomplish the above object, a tube for a heat exchanger according to the present invention includes a plurality of fluid paths formed along an extrusion direction through which the fluid for heat exchange flow. The present invention includes a tube main body formed by extrusion molding to have a long plate shape in the extrusion direction. In the present invention, at least either an upper surface part of the tube main body or a lower surface part of the tube main body is pressed in a direction to form a plurality of concave parts with intervals in the extrusion direction. Convex parts can be formed in the fluid paths by the pressed concave parts. The convex parts project in a direction so that a cross sectional area of the fluid paths is narrowed.

Preferably, the concave parts are formed to have a groove shape extending obliquely against an orthogonal direction of the extrusion direction of the tube main body.

Preferably, the interval of the groove shaped concave parts in the extrusion direction is set to be wider than intervals between wave peaks of wave shaped fins layered for usage.

Preferably, a non-forming area is disposed at both end parts of the extrusion direction of the tube main body in which the concave parts are not formed.

Preferably, the concave parts are formed on both the upper surface part of the tube and the lower surface part of the tube. In addition, the concave parts at the upper surface part of the tube and the concave parts at the lower surface part of the tube are disposed to not double in a thickness direction of the tube.

Preferably, a non-forming area is disposed at both end parts of the orthogonal direction of the extrusion direction in which the concave parts are not formed.

In addition, to accomplish the above object, the tube according to the present invention used for the heat exchanger is laminated together with the fins for the heat exchanger and is manufactured by a process of obtaining a metal made tube main body with a long plate shape in the extrusion direction by extrusion molding in which a plurality of fluid paths with an internal flow of the fluid for heat exchange is formed along the extrusion direction. The process also includes forming a plurality of concave parts with intervals in the extrusion direction in at least either the upper surface part of the tube or the lower surface part of the tube.

The concave parts are obtained by pressing at least either the upper surface part of the tube or the lower surface part of the tube. The upper surface part of the tube is a surface of one side of the thickness direction of the tube main body. The lower surface part of the tube is a surface of a reverse direction to the upper surface part. A plurality of convex parts can be formed by the pressed concave parts in the fluid paths with intervals in the extrusion direction. The convex parts are projected in a direction that narrows the cross sectional area of the fluid paths.

Preferably, the concave parts are formed to have a groove shape, extending obliquely against an orthogonal direction of the extrusion direction of the tube main body.

Preferably, the interval of the groove shaped concave parts in the extrusion direction is set to be wider than intervals between wave peaks of wave shaped fins laminated for usage.

Preferably, a non-forming area is disposed at both end parts of the extrusion direction of the tube main body in which the concave parts are not formed.

Preferably, the concave parts are formed on both the upper surface part of the tube and the lower surface part of the tube. In addition, the concave parts at the upper surface part of the tube and the concave parts at the lower surface part of the tube are disposed to not double in a thickness direction of the tube.

Preferably, a non-forming area is disposed at both end parts of the orthogonal direction of the extrusion direction in which the concave parts are not formed.

Furthermore, to accomplish the above object, a manufacturing method of the tube for the heat exchanger according to the present invention includes forming a plurality of fluid paths along the extrusion direction with an internal flow of the fluid for heat exchange, forming the tube main body with the plurality of the fluid paths by extrusion molding and laminating for usage the tube main body together with the fins for heat exchange, pressing at least either the upper surface of the tube or the lower surface of the tube to form a plurality of concave parts with intervals in the extrusion direction in which the upper surface of the tube is a surface of one side of the thickness direction of the tube main body and the lower surface part of the tube is a surface of a reverse direction to the upper surface part and forming by the pressed concave parts a plurality of convex parts with intervals in the extrusion direction and projected in a direction that narrows a cross sectional area of the fluid paths.

Preferably, the concave parts are formed to have a groove shape extending obliquely against an orthogonal direction of the extrusion direction of the tube main body.

Preferably, the interval of the groove shaped concave parts in the extrusion direction is set to be wider than intervals between wave peaks of wave shaped fins laminated for usage.

### EFFECTS OF THE INVENTION

In a tube for a heat exchanger according to the present invention, convex parts are formed in liquid paths with intervals in an extrusion direction. Therefore, disturbances are generated by the convex parts to a fluid flowing through the fluid paths so that contacts to an external circumference surface of the fluid paths by the fluid are facilitated. Consequently, a high heat transfer efficiency can be obtained. In addition, in the tube for the heat exchanger according to the present invention and the manufacturing method thereof, after the tube for the heat exchanger is molded by extrusion molding, at least either an upper surface part of the tube or a lower surface part of the tube is pressed so that concave parts are formed in these surfaces. By the pressed concave parts, convex parts are formed in the internal fluid paths. Therefore, as described above, in order to mold the tube for the heat exchanger with an excellent heat transfer efficiency, the tube can be manufactured by simple pressings of extrusion molding, roll molding and press molding or the like and manufacturing costs can be suppressed.

In addition to the above effects, groove shaped concave parts are formed to extend obliquely against an orthogonal direction of the extrusion direction of the tube for the heat exchanger. Therefore, in the case wave shaped fins are layered onto the tube for the heat exchanger, there are cases in which a wave peak part of one of the fins doubles a groove shaped concave part across its whole length so that the wave peak part contacts neither the upper nor the lower surface of the tube. Such defects are not generated in the present invention. As a result, a high heat transfer efficiency can be obtained in comparison to a case in which one wave peak part of a fin is in a non-contact state across its whole length along the groove shaped concave part.

Furthermore, because intervals of the groove shaped concave part is set to be wider than intervals between wave forms of the fins to be layered, there are occurrences in which a wave peak of a fin doubles a groove shaped concave part to generate a non-contact area. The number of such occurrences can be suppressed and heat transfer efficiency can be heightened.

A non-forming area is disposed at both end parts of the extrusion direction of the tube in which concave parts are not formed. Therefore, in the case both ends of the tube for the exchanger according to an embodiment of the present invention are inserted for usage into a tank which is a reservoir of the fluid for heat transfer use, in comparison to a case in which concave parts exist in the inserted part, seal properties can be easily secured.

In addition, concave parts in the upper surface part of the tube and the lower surface part of the tube are not doubled in the thickness direction of the tube. Therefore, in comparison to a case in which the concave parts are doubled in the thickness direction of the tube in disposition, bend overs generated in the thickness direction of the tube for the heat exchanger can be suppressed.

In addition, a non-forming area is disposed at both end parts of an orthogonal direction of the extrusion direction of the tube for the heat exchanger in which concave parts are not formed. Therefore, in comparison to a case in which concave parts are formed in the both end parts, bend overs generated in the thickness direction of the tube for the heat exchanger can be suppressed.

### BRIEF DESCRIPTION OF THE DRAWINGS

FIG. 1A is a plain view that illustrates a tube 1 for a heat exchanger of an embodiment 1.

FIG. 1B is a longitudinal cross sectional diagram that illustrates a state in which the tube 1 for the heat exchanger of the embodiment 1 is cut along a part not formed with groove shaped concave parts 1e.

FIG. 1C is a longitudinal cross sectional diagram that illustrates a state in which the tube 1 for the heat exchanger of the embodiment 1 is cut along a part formed with groove shaped concave parts 1e.

FIG. 2 is a perspective view that illustrates a heat exchanger A including the tube 1 of the embodiment 1.

FIG. 3 is a perspective view that illustrates a thief part of the heat exchanger A including the tube 1 of the embodiment 1.

FIG. 4 is an enlarged longitudinal cross sectional diagram that illustrates a chief part of the tube 1 of the embodiment 1.

FIG. 5 is a descriptive diagram of a roll processing when manufacturing the tube 1 for the heat exchanger of the embodiment 1.

FIG. 6 is a descriptive diagram of a press processing when manufacturing the tube 1 for the heat exchanger of the embodiment 1.

FIG. 7 is a property comparison diagram that illustrates against a conventional heat exchanger, an improvement ratio of a heat transfer efficiency of the heat exchanger A in which the tube 1 of the embodiment 1 is used.

FIG. 8 is a plain view that illustrates a tube 201 for a heat exchanger of an embodiment 2.

FIG. 8B is a plain view that illustrates a tube 202 for a heat exchanger of the embodiment 2.

FIG. 9A is a plain view that illustrates a tube 301 for a heat exchanger of an embodiment 3.

FIG. 9B is a cross-sectional diagram that illustrates the tube 301 for the heat exchanger of the embodiment 3.

FIG. 10A is a plain view that illustrates a tube 301 for a heat exchanger of an embodiment 4.

FIG. 10B is a cross-sectional diagram that illustrates the tube 301 for the heat exchanger of the embodiment 4.

FIG. 11A is a plain view that illustrates a tube 301 for a heat exchanger of an embodiment 5.

FIG. 11B is a cross-sectional diagram that illustrates the tube 301 for the heat exchanger of the embodiment 5.

### DESCRIPTION OF THE NUMERALS

1 tube for a heat exchanger

1a fluid path

1b convex part

1c upper surface part of the tube

1d lower surface part of the tube

1e groove shaped concave part

1f non-forming area

1g non-forming area

5 fin

5a wave peak

10 tube main body

201 tube for a heat exchanger

201e groove shaped concave part

202 tube for a heat exchanger

202e groove shaped concave part

301 tube for a heat exchanger

301e dimple

401 tube for a heat exchanger

401e groove shaped concave part

501 tube for a heat exchanger

501e groove shaped concave part

A heat exchanger

### BEST MODE FOR CARRYING OUT THE INVENTION

An embodiment of the present invention is described based on the accompanying drawings hereinbelow. A tube for a heat exchanger according to the present invention includes a tube main body 10 formed by extrusion molding with a plurality of fluid paths 1a through each of which a fluid for a heat exchanger flows internally along an extrusion direction and formed to have a long plate shape in the extrusion direction. The tube also includes a plurality of concave parts formed with intervals in the extrusion direction in at least either an upper surface part of the tube or a lower surface part of the tube. The concave parts are obtained by pressing at least either an upper surface part of the tube or a lower surface part of the tube. The upper surface part of the tube is a surface of one side of a thickness direction of the tube main body. The lower surface part of the tube is a surface of a reverse direction to the upper surface part. The pressing is applied in a direction so that a plurality of convex parts can be formed by the pressed concave parts in the fluid paths. The convex parts are projected in a direction that narrows the cross sectional area of the fluid paths.

### Embodiment 1

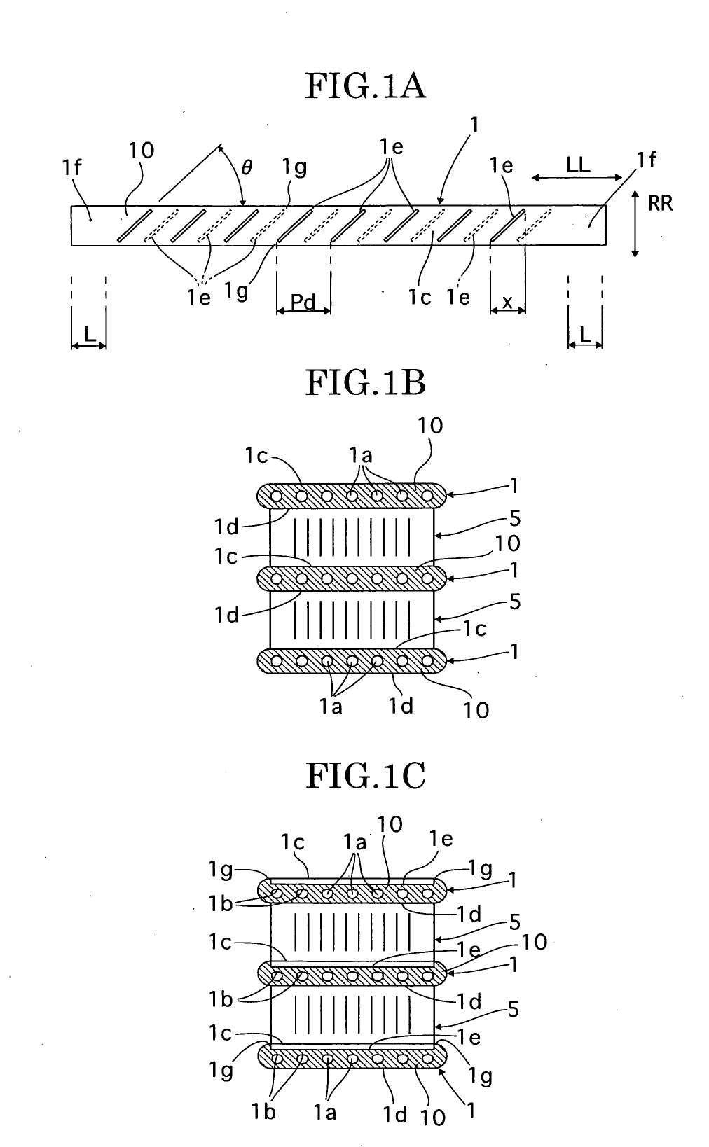

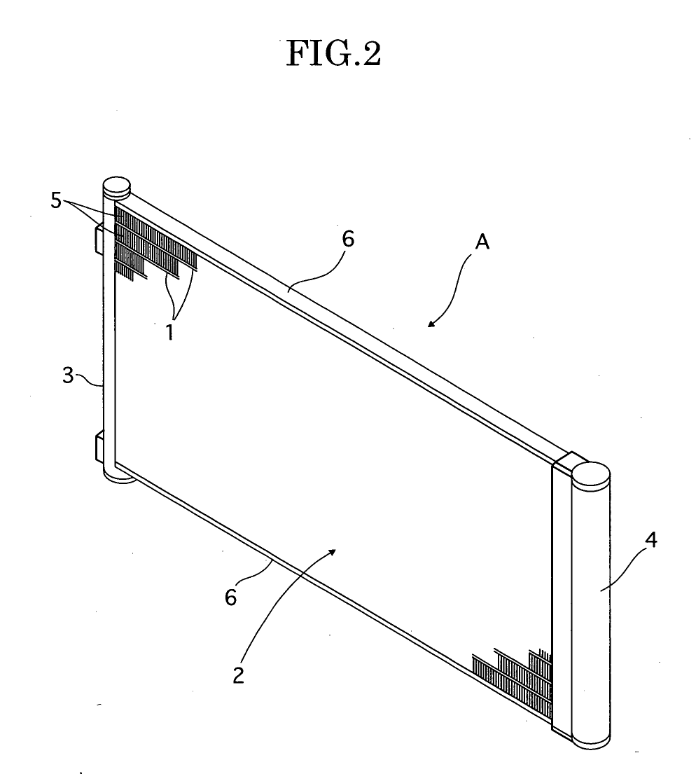

A heat exchanger A of an embodiment 1, that is, a best embodiment of the present invention is described hereinbelow based on FIG. 1A through FIG. 7 in which a tube 1 is used.

As illustrated in FIG. 2, a constitution is adopted in which the left and the right of a core part 2 of the heat exchanger A are supported by header tanks 3 and 4. A fluid for a heat exchanger such as cooling water or the like is supplied and discharged from the header tanks 3 and 4. In the core part 2, a plurality of tubes 1 for the heat exchanger and a plurality of fins are layered alternatively. A top and a bottom of the layered structure are put between a pair of plates 6 and 6.

The tube 1 for the heat exchanger includes a tube main body 10 of a long plate shape that performs heat transfer with outside air by flowing a fluid for heat exchange internally. For example, metals of aluminum and copper or the like with high heat transfer efficiency are extrusion molded for the tube main body 10. The tube main body 10 is formed to have a rectangular plate shape when viewed from above as illustrated in FIG. 1A. In addition, a plurality of fluid paths la (refer to FIG. 1B) is formed internally along a whole length of the extrusion direction (LL direction in the figure) with a circular cross section through which the fluid flows.

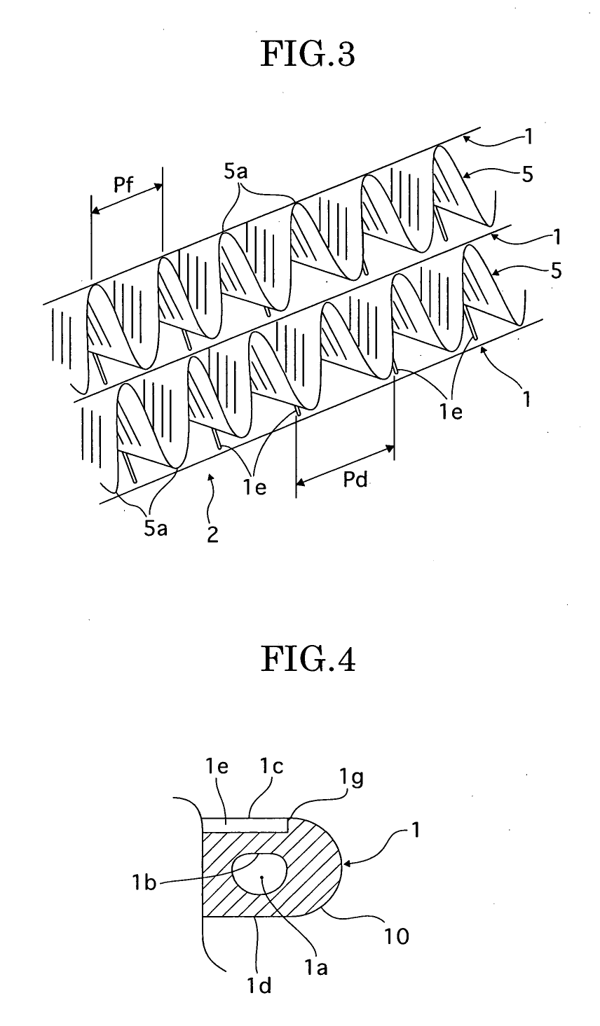

Heat transfer to the outside air by the tube 1 for the heat exchanger is helped by a fin 5. For example, the fin 5 is formed from metals with a high heat transfer efficiency of aluminum and copper or the like to have a thin plate shape and a wave shape as illustrated in FIG. 3.

Furthermore, in the embodiment 1, as illustrated in FIG. 1C, a plurality of convex parts 1b are formed with intervals in the extrusion direction of the fluid paths 1a of the tube for the heat exchanger. The plurality of convex parts project internally to narrow a cross-sectional area of the fluid paths.

After the tube main body 10 is extrusion-molded, by a roll molding or a press molding, an upper surface part 1c of the tube and a lower surface part 1d of the tube are pressed to be deformed by their plasticity so that the convex parts 1b can be formed. The upper surface part 1c of the tube is a surface of one side of the thickness direction of the tube main body 10. The lower surface part 1d of the tube is a surface of a reverse direction to the upper surface part 1c. As illustrated in FIG. 1A, a plurality of groove shaped concave parts 1e is shaped in the pressed points. As illustrated in FIG. 1C, in parts formed with the groove shaped concave parts 1e, each fluid path 1a is pressed in a thickness direction of the tube as a result. Therefore, the convex parts 1b narrowing the cross sectional area of the fluid path are formed by the pressed concave parts 1e.

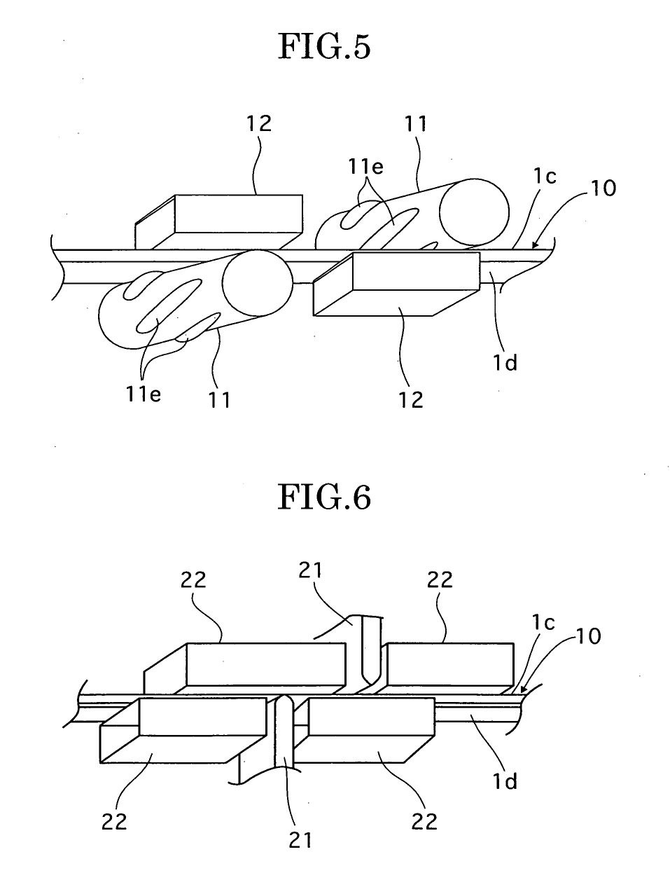

In the case of the roll molding, as illustrated in FIG. 5 as one example, the tube main body 10 is put between a pair of rollers 11 for molding use and a supporting base 12. In order to be molded, the roller 11 for molding use is moved by rolling along either the upper surface part 1c of the tube or the lower surface part 1d of the tube and the supporting base 12 is moved along a surface of a reverse side to either the upper surface part 1c or the lower surface part 1d. In addition, convex streaks 11e for shaping the groove shaped concave parts 1e are formed on an external circumference surface of the roller 11.

In addition, in the case of press molding, as illustrated in FIG. 6 as one example, in order to be molded, either the upper surface part 1c of the tube 10 or the lower surface part 1d of the tube 10 is pressed by a press mold 21 and a surface of a reverse side to either the upper surface part 1c or the lower surface part 1d is supported by a supporting base 22. In addition, a pair of the supporting bases 22 and 22 are disposed so that the press mold 21 is put between. The pair of the supporting bases 22 and 22 is also used as presser bars of a part pressed by the press mold 21.

The groove shaped concave parts 1e shaped as described above are formed with an angle θ (θ<90) against the extrusion direction (a direction of an arrow LL) of the tube 1 for the heat exchanger, that is, to extend obliquely against a width direction (a direction of an arrow RR) which is orthogonal to the extrusion direction and with a constant pitch Pd as illustrated in FIG. 1A. Furthermore, with regard to the groove shaped concave parts 1e, those formed on a side of the upper surface part 1c of the tube main body 10 of the tube 1 for the heat exchanger (illustrated by solid lines in the figure) and those formed on a side of the lower surface part 1d of the tube (illustrated by dotted lines in the figure) are formed alternately in the extrusion direction.

In addition, the pitch Pd of the groove shaped concave part 1e is set to be wider than a pitch Pf of a wave peak 5a which is a part of a wave shaped mountain of the fin 5 as illustrated in FIG. 3. In addition, a length (refer to FIG. 1A) of one groove shaped concave part 1e in the extrusion direction (the direction of the arrow LL) is set to have a longer dimension than the pitch Pf of the wave peak 5a of the fins 5.

Furthermore, in the present embodiment 1, the groove shaped concave parts 1e are not formed across an entire area in the extrusion direction (the direction of the arrow LL) of the tube main body 10 of the tube 1 for the heat exchanger. Non-forming areas 1f and 1f are set at both end parts of the extrusion direction in which the groove shaped concave parts 1e are not formed. In both ends of the extrusion direction of the tube main body 10 of the tube 1 for the heat exchanger, the non-forming area 1f is set to have a longer dimension L than the parts to be inserted into the header tanks 3 and 4.

In addition, in the width direction (the direction of the arrow RR) of the tube 1 for the heat exchanger, the groove shaped concave parts 1e are not formed across a whole width of the tube main body. Non-forming areas 1g and 1g are also set at both end parts of the width direction of the tube main body 10 in which the groove shaped concave parts 1e are not formed. That is, as illustrated in FIG. 4, an outermost fluid path 1a disposed in the width direction of the tube main body 10 of the tube 1 for the heat exchanger has a position. The groove shaped concave parts 1e are only formed to the position. Further outward areas are defined as the non-forming area 1g.

Next, operations of the embodiment 1 are described. In the case the tube 1 for the heat exchanger of the embodiment 1 is formed, first, the tube main body 10 is formed. The tube main body 10 is formed internally with a plurality of liquid paths 1a by extrusion molding. Thereafter, by the pressing according to the roll molding illustrated in FIG. 5 or by the pressing according to the press molding illustrated in FIG. 6, groove shaped concave parts 1e are formed in a constant pitch Pd in the upper surface part 1c of the tube and the lower surface part 1d of the tube so that when these groove shaped concave parts 1e are formed, convex parts 1b are formed in the liquid path 1a of at the pressed parts.

The tube 1 for the heat exchanger manufactured as such is then layered alternately with the fin 5. The top and the bottom of the laminated body are put between a pair of plates 6 and 6 to form the core part 2. Both ends of the core part 2 are inserted into the header tanks 3 and 4 to form the heat exchanger A.

In the tube 1 for the heat exchanger of the embodiment 1 formed as such, disturbances are generated by the convex parts to a fluid flowing through the liquid paths so that contacts by the fluid to an external circumference surface of the fluid paths are facilitated and heat transfer efficiency is heightened.

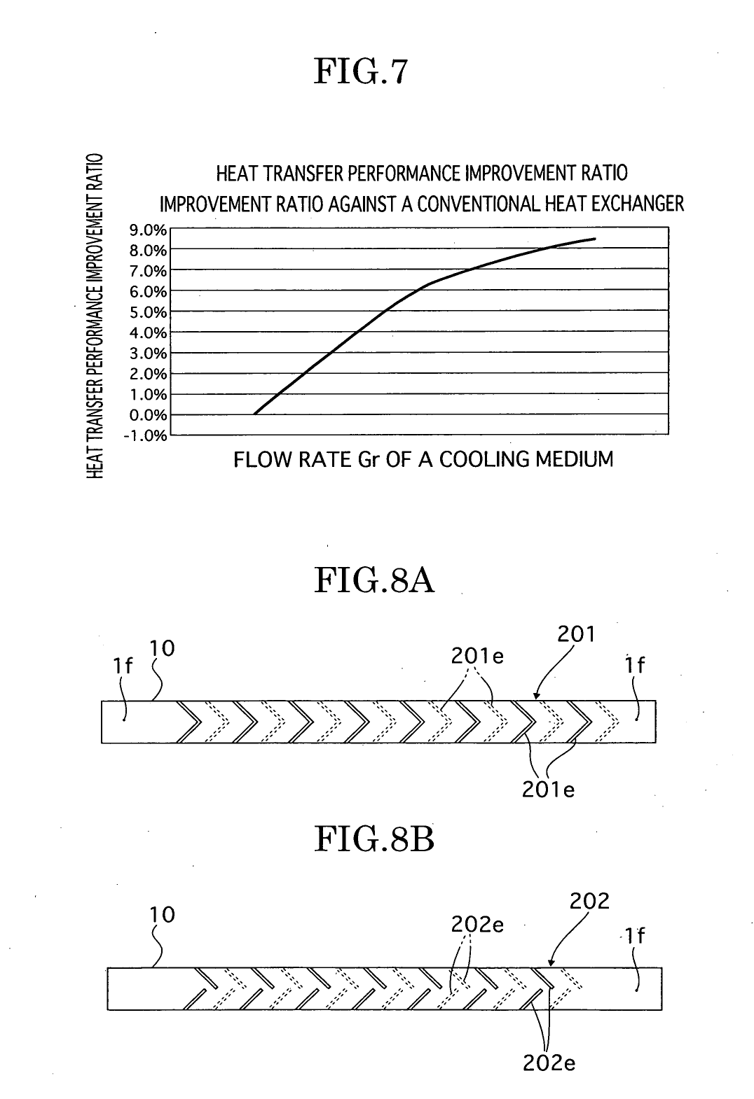

FIG. 7 is a property comparison diagram that illustrates an improvement ratio of heat transfer efficiency of the heat exchanger A in which the tube 1 of the embodiment 1 is used vis-à-vis a conventional heat exchanger in which the tube without the convex part 1b is used. The diagram illustrates that the higher a flow rate Gr of the fluid (cooling medium), the higher is the improvement ratio of heat transfer capabilities.

In addition, in the forming of the tube 1 for the heat exchanger of the embodiment 1, after the tube is formed by extrusion molding, convex parts 1b are formed in the liquid paths 1a by pressings of roll molding or press molding. Therefore, the tube 1 for the heat exchanger can be manufactured by simple processings and manufacturing costs can be suppressed.

Furthermore, in the tube 1 for the heat exchanger of the embodiment 1, the groove shaped concave parts 1e are extended obliquely against the width direction of the tube 1 for the heat exchanger so that an excellent contact property with the fin 5 is obtained. That is, in the case the groove shaped concave parts 1e are formed in the width direction, there is possibility that the groove shaped concave parts 1e doubles the wave peak 5a of the fin 5 in disposition. In that case, the wave peak 5a is not in contact with the upper surface part 1c of the tube or the lower surface part 1d of the tube across an approximate whole length of the width direction so that heat transfer efficiency of this part is worsened. In comparison, in the present embodiment 1, the groove shaped concave parts 1e are formed obliquely against the width direction. Therefore, there is no possibility that the wave peak 5a of the fin 5 maintains a non-contact state across its approximate whole length in the way just described. Consequently, worsening of heat transfer efficiency can be suppressed.

In addition, in the case the groove shaped concave parts 1e are extended obliquely in such a way, a part of the wave peak 5a of the fin 5 intersecting and doubling the groove shaped concave part is not in contact with the upper surface part 1c of the tube or the lower surface part 1d of the tube. But an area of the part is small and a periphery of the part is necessarily in contact with these upper and lower surface parts 1c and 1d. Therefore, heat transfer efficiency can be heightened in comparison to the case in which the wave peak 5a is not in contact across its approximate whole length. In addition, in the embodiment 1, the pitch Pd of the groove shaped concave part 1e is set to be larger than the pitch Pf of the wave peak 5a of the fin 5. Therefore, in comparison to a case in which Pd<Pf, occurrences of non-contact areas, that is, intersection areas between the groove shaped concave parts 1e and the wave peak 5a of the fin 5 can be suppressed so that heat transfer efficiency can be heightened.

Furthermore, in the present embodiment 1, a length x in the extrusion direction of the concave shaped groove parts 1e is set to be wider than the pitch Pf of the wave peak 5a of the fin 5 so that a plurality of peaks are doubled to one groove shaped concave part 1e. In such a way, the wave peak 5a gets into the groove shaped concave part 1e and a rolled over state of the fin 5 can be prevented. Also in such a way, a good state of contact between the fin 5 and the tube 1 for the heat exchanger can be secured and heat transfer efficiency can be heightened.

In addition, in the embodiment 1, non-forming areas if and if are disposed at both end parts of the extrusion direction of the tube 1 for the heat exchanger in which the groove shaped concave parts 1e are not formed. Therefore, in the case both ends of the tube 1 for the exchanger are inserted into header tanks 3 and 4, in comparison to a case in which the groove shaped concave parts 1e exist in the inserted part, seal properties can be easily secured.

In addition, in the embodiment 1, groove shaped concave parts in the upper surface part 1c of the tube 1 for the heat exchanger and the lower surface part 1d of the tube 1 are formed alternately. Therefore, in comparison to a case in which the groove shaped concave parts 1e of both surfaces 1c and 1d are doubled in the thickness direction, bend overs of the tube 1 for the heat exchanger in the thickness direction of the tube at the position of the groove shaped concave parts 1e can be suppressed. In addition, non-forming areas 1g and 1g are also set at both end parts of the width direction of the tube 1 for the heat exchanger. An outermost fluid path 1a disposed in the width direction of the tube has a position. The groove shaped concave parts 1e are only formed to the position. Therefore, in comparison to a case in which the groove shaped concave parts are formed across a whole width of the tube 1 for the heat exchanger, bend overs of the tube 1 for the heat exchanger in the thickness direction of the tube at the position of the groove shaped concave parts 1e can be suppressed.

### Embodiment 2

Next, based on FIG. 8A and FIG. 8B, a tube 201 and a tube 202 for a heat exchanger of an embodiment 2 of the present invention are described. In addition, the embodiment 2 is a modified example of the embodiment 1. Therefore, only differing points are described. Descriptions of the same constitutions, operations and effects as the embodiment 1 are abbreviated.

In the embodiment 2, shapes of groove shaped concave parts 201e and 202e of the tube 201 and 202 for the heat exchanger differ from that of embodiment 1. That is, the groove shaped concave parts 201e illustrated in FIG. 8A are formed to have a V letter shape as illustrated hereby. In addition, the groove shaped concave parts 202e of the tube 202 for the heat exchanger, as illustrated in FIG. 8B, is an example in which two pieces constituting a V letter are formed alternately. In addition, descriptions of operations and effects are the same to the embodiment 1 so that they are abbreviated.

### Embodiment 3

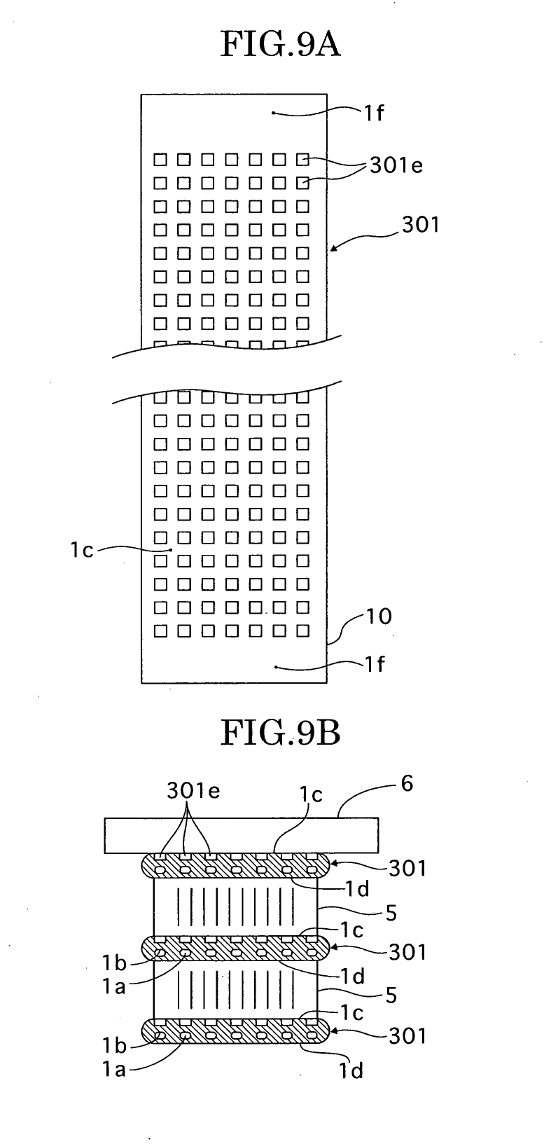

Next, based on FIG. 9A and FIG. 9B, a tube 301 for a heat exchanger of an embodiment 3 of the present invention are described. In addition, the embodiment 3 is a modified example of the embodiment 1. Therefore, only differing points are described. Descriptions of the same constitutions, operations and effects as the embodiment 1 are abbreviated.

The tube 301 for the heat exchanger of the embodiment 3, as illustrated in FIG. 9A, is an example in which a plurality of lines and a plurality of columns of dimples are formed in an upper surface part 1c of the tube. The dimples are approximately square shaped when viewing concave parts from above.

In the embodiment 3, the dimples 301e are formed as the concave parts. Therefore, in comparison to a case in which the groove shaped concave parts are formed across a whole width of a width direction of areas formed with the dimples 301e, contact areas with the fin 5 are secured and heat transfer efficiency can be heightened. In comparison to a case in which the groove shaped concave parts are formed, bend overs of the tube 301 for the heat exchanger can be suppressed. In addition, the wave peak 5a of the fin 5 is fitted into a groove so that a roll over is prevented.

In addition, the embodiment 3 is also the same to the embodiment 1 in that firstly, heat transfer efficiency can be heightened in comparison to a case in which the convex parts 1b are not formed; secondly, manufacturing costs can be suppressed due to simple manufacture by extrusion molding, roll molding or press molding and thirdly, seal properties can be easily secured due to the non-forming area 1f at both end parts of the extrusion direction.

### Embodiment 4

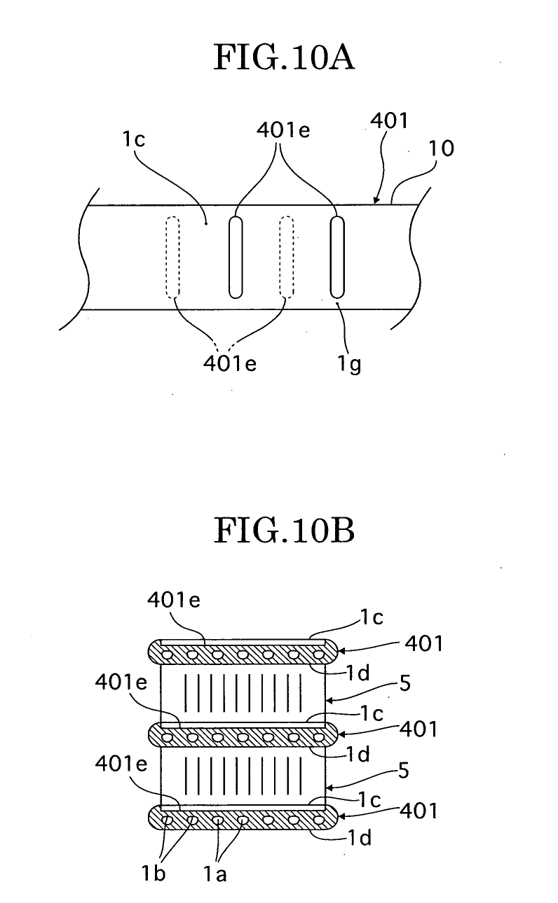

Next, based on FIG. 10A and FIG. 10B, a tube 401 for a heat exchanger of an embodiment 4 of the present invention are described. In addition, the embodiment 4 is a modified example of the embodiment 1. Therefore, only differing points are described. Descriptions of the same constitutions, operations and effects as the embodiment 1 are abbreviated.
the tube 401 for the heat exchanger of the embodiment 4, as illustrated in

FIG. 10, is an example in which groove shaped concave parts 401e are formed in the width direction in the upper surface part 1c of the tube and the lower surface part 1d of the tube so that convex parts 1b are formed by the pressed concave parts 401e. In addition, a pitch Pd of the groove shaped concave parts 401e is shaped to be larger than a pitch Pf of the wave peak 5a of the fin 5. In addition, the non-forming area 1g is formed in both end parts of the width direction.

In addition, the embodiment 4 is also the same to the embodiment 1 in that firstly, heat transfer efficiency can be heightened in comparison to a case in which the convex parts 1b are not formed; secondly, manufacturing costs can be suppressed due to simple manufacture by extrusion molding, roll molding or press molding, thirdly, seal properties can be easily secured due to the non-forming area 1f at both end parts of the extrusion direction and fourthly, the tube 401 becomes difficult to be bent over because groove shaped concave parts 401e are formed alternately in the upper and lower surface parts 1c and 1d and the non-forming area 1g is set.

### Embodiment 5

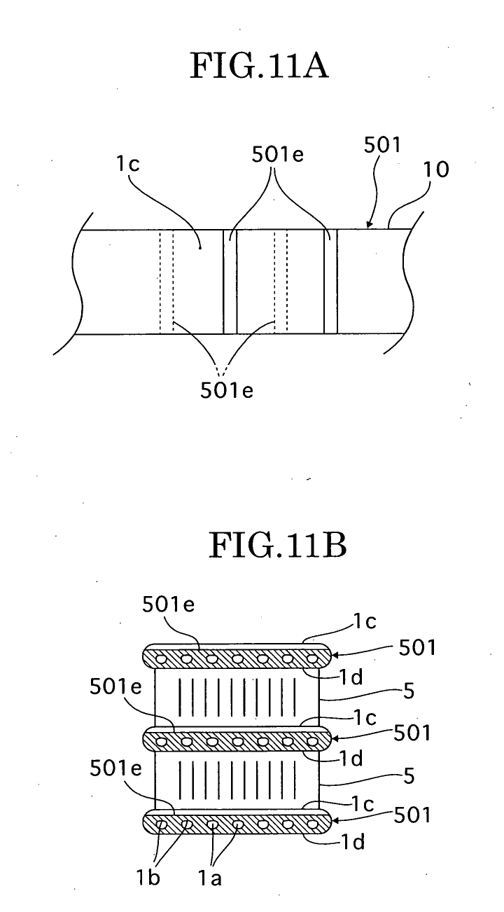

Next, based on FIG. 11A and FIG. 11B, a tube 501 for a heat exchanger of an embodiment 5 of the present invention are described. In addition, the embodiment 5 is a modified example of the embodiment 1. Therefore, only differing points are described. Descriptions of the same constitutions, operations and effects as the embodiment 1 are abbreviated.
the tube 501 for the heat exchanger of the embodiment 5, as illustrated in FIG. 11A, is an example in which groove shaped concave parts 501e are formed in the width direction across a whole width of the upper surface part 1c of the tube and the lower surface part 1d of the tube so that convex parts 1b are formed by the pressed concave parts 501e. In addition, a pitch Pd of the groove shaped concave parts 1e is shaped to be larger than a pitch Pf of the wave peak 5a of the fin 5. In addition, the non-forming area 1g is formed in both end parts of the width direction.

In addition, the embodiment 5 is also the same to the embodiment 1 in that firstly, heat transfer efficiency can be heightened in comparison to a case in which the convex parts 1b are not formed; secondly, manufacturing costs can be suppressed due to simple manufacture by extrusion molding, roll molding or press molding, thirdly, seal properties can be easily secured due to the non-forming area 1f at both end parts of the extrusion direction and fourthly, the tube 501 becomes difficult to be bent over because groove shaped concave parts 501e are formed alternately in the upper and lower surface parts 1c and 1d.

The embodiment 1 through 5 of the present invention and the best mode for carrying out the invention are described in detail above with reference to the drawings but the specific constitutions are not limited to the embodiment 1 through 5 and the best mode for carrying out the invention. A degree of changes in design that does not deviate from the scope of the invention is included in the present invention.

For example, in the embodiment 1 through 5, the shape of the fluid paths 1a is circular in its cross section but shape is not limited to such and the fluid paths 1a can be formed to other shapes such as polygonal shapes of rectangles or the like as well as elliptical shapes. The number of the fluid paths is also not limited to the number illustrated in the embodiments. For example, in the embodiments, the fluid paths 1a are formed into one lateral line but the fluid paths 1a can have a different array with the embodiments in which two lateral lines are formed or the like.

In addition, in the embodiments 1 through 5, the thin plate shaped fin 5 of a wave form is illustrated as a fin but the shape of the fin is not limited to this. For example, a fin of other shapes such as a flat plate shape or a honeycomb shape or the like can be used. In addition, the fin can differ from a contact type of the embodiment 1 through 5 and a welding type can be used.

In addition, in the embodiments 1 through 5, an example is illustrated in which the concave parts are formed on both the upper and the lower surface of the tube 1 for the exchanger but the concave parts can be formed only on either the upper surface or the lower surface.

In addition, in the embodiments 1 through 5, when the tube 1 for the heat exchanger and the fin 5 are layered, an example is illustrated in which the tube 1 for the heat exchanger and the fin 5 are disposed alternately but it is not limited to such. For example, one tube can be put between two fins to form a laminated body and a plurality of the laminated body can then be layered.

In addition, in the case convex parts are formed by the dimples 301e illustrated in the embodiment 3, a plain surface shape of the dimples are not limited to the rectangle illustrated in the embodiment 3 but the dimples can formed to other shapes of triangle and round or the like. In addition, in this case, projections formed by the dimples have shapes of rectangular spindles, triangular pyramids and circular cones or the like so that the shape of the convex parts can be a shape that projects by point instead of projecting from one side of the fluid path 1a towards the entire fluid path 1a as illustrated in the embodiment 1 through 5.

The present invention is based on and claims priority benefit from Japanese Patent Application No. 2006-283529, filed on Oct. 18, 2006, the disclosure of which is incorporated herein by reference in its entirety.

In addition, the present invention is not limited to the above embodiments. It is clear to those skilled in the art that changes can be made without deviating from the claims and the scope thereof.

1. A tube for a heat exchanger, comprising:
a tube main body obtained by extrusion molding with a long plate shape in an extrusion direction and formed along the extrusion direction with a plurality of fluid paths through each of which a fluid for the heat exchange flows internally, and
a plurality of concave parts formed with intervals in a pressing direction, wherein
at least either an upper surface part of the tube which is a surface of one side in a thickness direction of the tube main body or a lower surface part of the tube which is a surface of a reverse direction to the upper surface part is pressed to form the concave parts, and
the concave parts are pressed in the direction to form as a result convex parts in the fluid paths which are projected in a direction that narrows a cross sectional area of each of the fluid path.

2. The tube for the heat exchanger according to claim 1, wherein
the concave parts are formed to have a groove shape and extend obliquely against an orthogonal direction of the extrusion direction of the tube main body.

3. The tube for the heat exchanger according to claim 2, wherein
the interval in the extrusion direction of the groove shaped concave part is set to be wider than an interval between wave peaks of wave shaped fins used for lamination.

4. The tube for the heat exchanger according to claim 1, further comprising:
a non-forming area disposed in both end parts of the extrusion direction of the tube main body in which the concave parts are not formed.

5. The tube for the heat exchanger according to claim 1, wherein
the concave parts are formed on both the upper surface part of the tube and the lower surface part of the tube in which the concave parts formed on the upper surface part of the tube and the concave parts formed on the lower surface part of the tube are disposed to not double in the thickness direction.

6. The tube for the heat exchanger according to claim 1, further comprising:
a non-forming area disposed in both end parts of the orthogonal direction of the extrusion direction in which the concave parts are not formed.

7. A process of manufacturing a tube for a heat exchanger, comprising the steps of:
obtaining by extrusion molding a tube main body of the tube for the heat exchanger laminated for usage with a fin for the heat exchanger in which the tube main body is metal made, long plate shaped in an extrusion direction and formed along the extrusion direction with a plurality fluid paths through which a fluid for heat exchange flows internally,
pressing at least either an upper surface part of the tube which is a surface of one side in a thickness direction of the tube main body or a lower surface part of the tube which is a surface of a reverse direction to the upper surface part to form a plurality of concave parts with intervals in the extrusion direction in at least either the upper surface part of the tube or the lower surface part of the tube, and
forming by the pressed concave parts a plurality of convex parts in the fluid paths with intervals in the extrusion direction and projected in a direction that narrows a cross sectional area of the fluid paths.

8. The tube for the heat exchanger according to claim 7, wherein
the concave parts are formed to have a groove shape and extend obliquely against an orthogonal direction to the extrusion direction of the tube main body.

9. The tube for the heat exchanger according to claim 8, wherein
the interval in the extrusion direction of the groove shaped concave part is set to be wider than an interval between wave peaks of wave shaped fins used for lamination.

10. The tube for the heat exchanger according to claim 7, further comprising:
a non-forming area disposed in both end parts of the extrusion direction of the tube in which the concave part is not formed.

11. The tube for the heat exchanger according to claim 7, wherein
the concave parts are formed on both the upper surface part of the tube and the lower surface part of the tube in which the concave parts formed on the upper surface part of the tube and the concave parts formed on the lower surface part of the tube are disposed to not double in the thickness direction.

12. The tube for the heat exchanger according to claim 7, further comprising:
a non-forming area disposed in both end parts of the orthogonal direction to the extrusion direction in which the concave part is not formed.

13. A manufacturing method of a tube for a heat exchanger, wherein
the tube for the heat exchanger is layered for usage with fins for heat transfer in which a plurality of the fluid paths through which a fluid for heat exchange flows internally is formed along an extrusion direction, comprising the steps of:
forming by extrusion molding a tube main body that includes the plurality of fluid paths,
pressing at least either an upper surface part of the tube which is a surface of one side in a thickness direction of the tube main body or a lower surface part of the tube which is a surface of a reverse direction to the upper surface part to form a plurality of concave parts with intervals in the extrusion direction, and
forming by the pressed concave parts a plurality of convex parts with intervals in the extrusion direction and projected in a direction that narrows a cross sectional area of the fluid paths.

14. The manufacturing method of the tube for the heat exchanger according to claim 13, wherein
the concave parts are formed to have a groove shape and extend obliquely against an orthogonal direction of the extrusion direction of the tube main body.

15. The manufacturing method of the tube for the heat exchanger according to claim 14, wherein
the interval in the extrusion direction of the groove shaped concave part is set to be wider than an interval between wave peaks of wave shaped fins used for lamination.
